(19) United States
(12) Patent Application Publication
(10) Pub. No.: US 2008/0068267 A1
(43) Pub. Date: Mar. 20, 2008

(54) Cost effective communication infrastructure for location sensing

(76) Inventors: Steve D. Huseth, Plymouth, MN (US); Andrew G. Berezowski, Wallingford, CT (US)

Correspondence Address: Kris T. Fredrick, Esq.;Patent Services, Honeywell International Inc., 101 Columbia Road, Morristown, NJ, 07962, US

(21) Appl. No.: 11/521,292

(22) Filed: Sep. 14, 2006

(51) Int. Cl. G01S 3/02; G08B 1/08

(52) U.S. Cl. 342/465; 340/539.13

(57) ABSTRACT

A system for tracking persons in a structure, using a mobile unit for transmitting a distinctive beacon signal to a wireless array network of RF transceivers when the signal is within a predetermined distance of one or more RF transceivers, and transmitting the received RF beacon signal and a signal representative of itself to other RF transceivers through the array to a computer gateway. The computer determines the location of the mobile unit from the transmitted signals and displays the location.

### FIELD OF THE INVENTION

The present invention relates to a tracking system for tracking people and assets in a controlled environment. More particularly, the present invention relates to a tracking system for firefighters and the like using a mesh information system such as a wireless mesh and gateway.

### BACKGROUND OF THE INVENTION

First responders such as fire fighters, police officers, and search and rescue teams are subject to numerous dangers. A significant contributor to these dangers is the potential of being lost or disoriented within a building that is filled with smoke and collapsed structures.

Radio Frequency (RF) based tracking systems rely on a combination of fixed beacons and mobile tags to track the movement of the tags, based on signal strength or time-of-flight measurements of specific RF signals. Near-continuous RF links with the beacons are necessary for the system to calculate timely location information. However, RF propagation variability may result in loss of path data for a mobile tag or tags. An alternative approach, which overcomes the RF link variability issue, employs a dead-reckoning module (DRM) in each mobile tag. The DRM can contain multiple sensors, such as altimeters, barometers, accelerometers, temperature sensors, and compass sensors, for example. The RF link is then used solely for data communications between the mobile tags and the base stations.

A number of solutions have been proposed for tracking and locating people and assets inside a building or structure using such a collection of location sensors that have been placed throughout a facility. These sensors use varying technologies to estimate distance to a mobile device that use techniques such as received signal strength indication (RSSI) and time of arrival (TOA). In each of these technical approaches, the accuracy of the distance measurement solution is directly proportional to the distance the mobile device that is being tracked is from the location sensing devices that have been placed throughout the facility. Furthermore, the accuracy is determined by having multiple location sensors in the vicinity of the mobile device. Consequently, for optimal performance, each of these location sensing techniques requires a large number of location sensors to be distributed throughout the facility roughly on a grid. The more sensors that are placed throughout the facility, the greater the accuracy of the location solution.

Placing a large number of location sensors on an evenly spaced grid throughout a facility can present a significant installation challenge. Each device must be connected such that it maybe powered and be able to communicate the location information sensed back to a gateway or display device where the location information may be displayed. This represents a significant installation challenge that can be extremely labor intensive and costly.

Another problem that exists is that the gateway or command center is used for a plurality of tasks, sometimes simultaneously, and a response to an injury or accident involving one or more of the mobile units may be overlooked for a short while or longer.

It would be of advantage in the art if a system could be devised that would permit the use of an array of location sensors that would be utilized in any pattern rather than in a precise grid.

Another advantage would be if the location sensors could transmit location information sensed and also relay information received from other sensors closer to the mobile object or on the mobile person measuring parameters such as heart rate, breathing, and ambient temperature.

Still another object would be if the gateway receiving the signals from a plurality of mobile units would immediately respond to a situation at one unit when that unit has certain criteria, such as an injured person.

Other advantages will appear hereinafter.

### SUMMARY OF THE INVENTION

It has now been discovered that the above and other advantages of the present invention may be obtained in the following manner. Specifically, the present invention includes the use of a mesh network to provide the communication to the gateway. In the preferred embodiment, the mesh network is wireless.

A plurality of sensors are placed at locations where the distance between the sensors is less than the maximum distance the mobile sensor is able to effectively transmit to insure that multiple fixed sensors are in communication with the mobile unit. Thus it is possible to use a similar radio to provide communication from one anchor to another. Since the mobile device must be capable of transmitting to multiple anchors, this placement of anchors insures that the anchors are also in range of each other and thus are capable of relaying their information from one anchor to another.

After several “hops” the last anchor would be within range of the gateway and can relay the information direct to the gateway, completing the data transfer. This “multi-hop” network will allow all the location sensors to be placed without the need for additional communication wires, greatly simplifying installation. The use of battery powered anchors allows for a completely “wireless” installation, greatly reducing the labor and time required for such installation.

The present invention is particularly suited for use in firefighting situations in buildings, where it is important to know the location and condition of each firefighter.

### BRIEF DESCRIPTION OF THE DRAWINGS

For a more complete understanding of the invention, reference is hereby made to the drawings, in which:

FIG. 1 is a schematic view of the present invention in which a person is inside an array of nine beacon receivers.

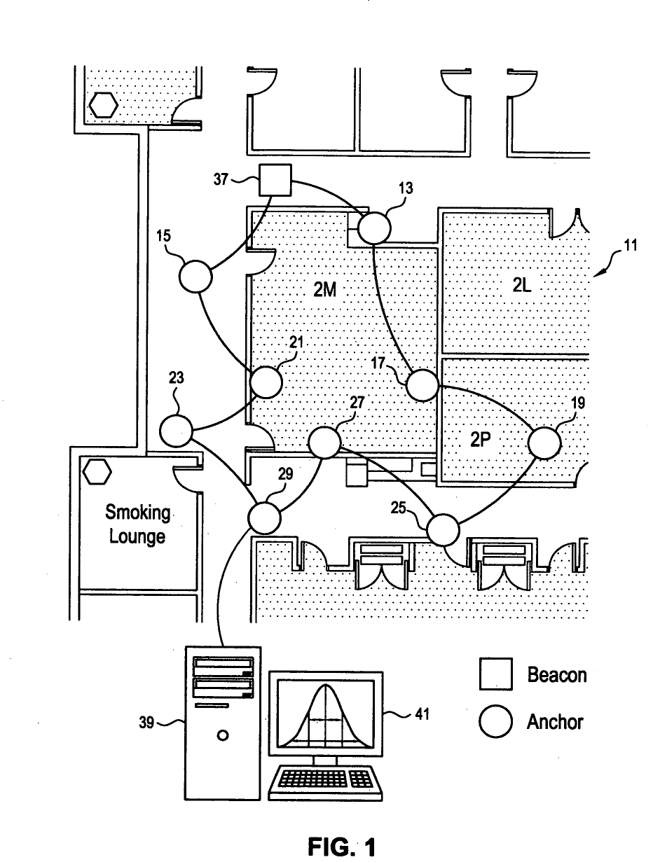

### DETAILED DESCRIPTION OF THE PREFERRED EMBODIMENT

The present invention is illustrated generally as 10 in the FIGURE, in which a portion of a structure 11 is shown with various rooms, such as 2F, 2L and 2M, plus a smoking lounge. In this FIGURE, there are nine anchors 13, 15, 17, 19, 21, 23, 25, 27 and 29, respectively, collectively referred to as 13-29.

Each node 13, 15, 17, 19, 21, 23, 25, 27 and 29 of the wireless mesh network serves two purposes, of sensing the signal strength and noting its time of arrival. The node or anchor uses a single radio that is able to both receive from the mobile unit and transmit to the next anchor. It is also possible to use a separate sensor radio that receives the mobile transmission. For the purposes of illustration, one beacon 37 has been shown in the FIGURE, but it is to be understood that there is no limit to the number of anchors and beacons that fall within the scope of the invention. In larger structures such as office buildings, hospitals, schools, stores, factories, warehouses, and the like, there may be hundreds or thousands of anchors. Similarly, there may be dozens or even hundreds of persons inside the structure whose location is to be monitored. One of the principle advantages of this invention is that while many locations and persons within the structure are being monitored or tracked, only those in need of assistance are the focus of the attention of the person or persons at the monitor.

As seen in the FIGURE, the beacon 37, which represents a person inside structure 11, transmits a signal to anchors 13 and 15 since they are within the range of the transmitter on beacon 37. In turn, anchor 13 relays or “hops” a signal to beacon 17, which hops to beacon 19, 25 27 and 29, which then communicates with gateway computer 39 and display 41. Signals from anchor 15 is relayed or hopped to anchors 23, 23, and 29, and then to the computer 39 and display 41.

The present invention is intended for use in any structure where it is desirable to monitor the location of persons or assets inside the structure. As noted above, the present invention is particularly suited for use in firefighting situations in buildings, where it is important to know the location and condition of each firefighter. Each firefighter carries a mobile unit and is tracked by the command center. Each mobile unit or beacon identifies itself to the sensors or anchors within its range of transmission, and each of those sensors or anchors transmits the distance to the mobile unit and its own location to other sensors or anchors so that the signal hops within the wireless mesh to the gateway and monitor in the command center. When the firefighter encounters an adverse situation, such as an injury, for example, the mobile unit or beacon transmits a distress signal along with its location signal.

In a preferred embodiment the processor in the command center is programmed to interrupt whatever is on the display to warn the command center of the adverse situation. This distress signal may be sent automatically, such as when a firefighter is immobile or does not move for a set period of time or has a reduced air supply, Or it may be sent by the intention of the user. In either case, the monitor preemptively displays the information needed to initiate a rescue. The rescue itself can be tracked by the command center and direct radio contact with the rescue unit can assist the rescuer.

The preferred monitor would have three display options: (1) not looking, such as when the user is doing other things, (2) looking at one or more mobile units, or (3) an alarm interrupting any other display, as noted above.

While particular embodiments of the present invention have been illustrated and described, it is not intended to limit the invention, except as defined by the following claims.

1. A system for tracking persons and other assets in a structure, comprising:
a mobile unit for transmitting a RF beacon signal, said signal being distinctive of the specific mobile unit;
a network of RF transceivers of known location forming a wireless array for receiving said RF beacon signal when said signal is within a predetermined distance of one or more of said network of RF transceivers, said one or more of said network of RF transceivers also transmitting said received RF beacon signal and a signal representative of itself to other of said network of RF transceivers proximate its location to deliver said received RF beacon signal through said array; and
a computer gateway for receiving said transmitted signals from said network and having a display, said computer being adapted to determine the location of said mobile unit from said transmitted signals and display said location on said display.

2. The system of claim 1, wherein said mobile units are carried by personnel responding to a specific situation in said structure.

3. The system of claim 2, wherein specific situation is selected from a fire, an explosion, a flood and the presence of undesirable gas or vapor.

4. The system of claim 3, wherein said specific situation is a fire and said personnel responding to said fire are firefighters.

5. The system of claim 1, which further includes a network of RF transceivers of known location forming a hard wired array, said hard wired array being configured to receive and transmit signals from said mobile units to said computer gateway.

6. The system of claim 1, wherein said mobile unit is one of a plurality of mobile units, each having its own signal distinctive of each specific mobile unit.

7. The system of claim 1, wherein said computer gateway is programmed to display selected individual mobile units.

8. The system of claim 7, wherein said computer gateway is programmed to preemptively display the signal from a specific individual mobile unit when said specific individual mobile unit intentionally transmits a preemptive signal.

9. The system of claim 7, wherein said computer gateway is programmed to preemptively display the signal from a specific individual mobile unit when said specific individual mobile unit automatically transmits a preemptive signal.

10. The system of claim 7, wherein said computer gateway is operational to display other information in the absence of a preemptive signal from any individual mobile unit.

11. A system for tracking persons and other assets in a structure, comprising:
a mobile unit means for transmitting a RF beacon signal, said signal being distinctive of the specific mobile unit means;
a network of RF transceiver means of known location for forming a wireless array for receiving said RF beacon signal when said signal is within a predetermined distance of one or more of said network of RF transceiver means, said one or more of said network of RF transceiver means also transmitting said received RF beacon signal and a signal representative of itself to other of said network of RF transceiver means proximate its location to deliver said received RF beacon signal through said array; and
a computer gateway means for receiving said transmitted signals from said network and having a display means, said computer means being adapted to determine the location of said mobile unit means from said transmitted signals and display said location on said display means.

12. The system of claim 11, wherein said mobile unit means are carried by personnel responding to a specific situation in said structure.

13. The system of claim 12, wherein specific situation is selected from a fire, an explosion, a flood and the presence of undesirable gas or vapor.

14. The system of claim 13, wherein said specific situation is a fire and said personnel responding to said fire are firefighters.

15. The system of claim 11, which further includes a network of RF transceiver means of known location forming a hard wired array, said hard wired array being configured to receive and transmit signals from said mobile unit means to said computer gateway means.

16. The system of claim 11, wherein said mobile unit means is one of a plurality of mobile unit means, each having its own signal distinctive of each specific mobile unit means.

17. The system of claim 11, wherein said computer gateway means is programmed to display selected individual mobile unit means.

18. The system of claim 17, wherein said computer gateway means is programmed to preemptively display the signal from a specific individual mobile unit means when said specific individual mobile unit means intentionally transmits a preemptive signal.

19. The system of claim 17, wherein said computer gateway means is programmed to preemptively display the signal from a specific individual mobile unit means when said specific individual mobile unit means automatically transmits a preemptive signal.

20. The system of claim 17, wherein said computer gateway means is operational to display other information in the absence of a preemptive signal from any individual mobile unit means.
